(19) United States
(12) Patent Application Publication
(10) Pub. No.: US 2008/0167112 A1
(43) Pub. Date: Jul. 10, 2008

(54) SLOT MACHINE AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 11/956,681

(22) Filed: Dec. 14, 2007

(30) Foreign Application Priority Data
Dec. 20, 2006 (JP) JP2006-343383

(51) Int. Cl. A63F 13/00

(52) U.S. Cl. 463/20

(57) ABSTRACT

A plurality of slot game areas is provided on a liquid crystal display and an area to be activated among the slot game areas is determined according to the number of bet credits or the number of inserted medals. Then, a slot game is executed in the activated slot game area. As a result, it is possible for a player to execute two or more slot games in one play. When a payline for which a payout is awarded is formed during the period of execution of the slot game, the area is enlarged and displayed on the liquid crystal display.

### CROSS REFERENCE TO RELATED APPLICATIONS

This application is based upon and claims the benefit of priority from the prior Japanese Patent Application No. 2006-343383, filed on Dec. 20, 2006, the entire contents of which are incorporated herein by reference.

### BACKGROUND OF THE INVENTION

1. Field of the Invention

The present invention relates to a slot machine and a playing method thereof.

2. Description of the Related Art

In a conventional slot machine, when a player inserts a predetermined number of medals into a medal insertion slot and operates a start button, a plurality of reels (e.g., three reels) on which a plurality of symbols is drawn spins individually. Then, after a lapse of a predetermined time, the reels stop. At this time, if symbols that form a winning combination stop on a preset payline, or if a predetermined number of scatter symbols stop, a payout is awarded according to the number of inserted medals.

On the other hand, in U.S. Pat. No. 6,855,052, a plurality of wheels provided above reels starts to spin sequentially if symbols displayed when the reels stop form a preset combination, and then the wheels stop. It is also described that if the outcome when the wheels stop is a predetermined one, a payout of many medals is awarded.

As described above, it is desired to provide a slot machine capable of executing the slot game a plurality of times for one-time medal insertion, instead of only once.

### SUMMARY OF THE INVENTION

The present invention has been achieved in order to solve the conventional problems and an object thereof is to provide a slot machine and a playing method thereof capable of improving its entertaining nature.

The gist of a first aspect of the present invention is a slot machine comprising: a display displaying a plurality of slot game areas for executing a slot game of rearranging a plurality of arranged symbols; an input device for reading a bet of credits by a player; and a controller operable to: (a) activate a slot game area according to the bet of credits read by the input device among the plurality of slot game areas; (b) execute the slot game in the activated slot game area; and (c) produce, when a winning combination awarding a payout is formed in any of the plurality of slot game areas, an enhanced display of the slot game area in which the winning combination is formed on the display.

The gist of a second aspect of the present invention is that the controller further produces, when a winning combination awarding a payout is formed in a plurality of slot game areas among the slot game areas, an enhanced display of the plurality of slot game areas in which the winning combination is formed sequentially on the display.

The gist of a third aspect of the present invention is a slot machine comprising: a display displaying a plurality of slot game areas for executing a slot game of rearranging a plurality of arranged symbols; an input device for reading a bet of credits by a player; and a controller operable to: (a) activate a slot game area according to the bet of credits read by the input device among the plurality of slot game areas; (b) execute the slot game in the activated slot game area; and (c) produce, when a winning combination awarding a payout is formed in any of the plurality of slot game areas, an enhanced display of the slot game area in which the winning combination is formed on the display and a sub display different from the display.

The gist of a fourth aspect of the present invention is that the controller further produces, when a winning combination awarding a payout is formed on a payline in a plurality of slot game areas among the slot game areas, an enhanced display of the plurality of slot game areas in which the winning combination is formed sequentially on the display and the sub display.

The gist of a fifth aspect of the present invention is a slot machine comprising: a display displaying a plurality of slot game areas for executing a slot game of rearranging a plurality of arranged symbols; an input device for reading a bet of credits by a player; and a controller operable to: (a) activate a slot game area according to the bet of credits read by the input device among the plurality of slot game areas; (b) execute the slot game in the activated slot game area; (c) delete, when a winning combination awarding a payout is formed in any of the plurality of slot game areas, the slot game area displayed on the display and in which the winning combination is formed from the display; and (d) produce an enhanced display of the slot game area in which the winning combination is formed on a sub display different from the display.

The gist of a sixth aspect of the present invention is that the controller further produces, when a winning combination awarding a payout is formed in a plurality of slot game areas among the slot game areas, an enhanced display of the plurality of slot game areas in which the winning combination is formed sequentially on the sub display.

The gist of a seventh aspect of the present invention is a playing method of a slot machine comprising the steps of: betting a credit; determining a slot game area to be activated according to the bet among a plurality of slot game areas in order to execute a slot game of rearranging arranged symbols; executing the slot game in the activated slot game area; and producing, when a winning combination awarding a payout is formed in any of the plurality of slot game areas, an enhanced display of the slot game area in which the winning combination is formed on the display.

The gist of an eighth aspect of the present invention is that the playing method of a slot machine further comprises the step of producing, when a winning combination awarding a payout is formed in a plurality of slot game areas among the slot game areas, an enhanced display of each of the plurality of slot game areas in which the winning combination is formed sequentially on the display.

The gist of a ninth aspect of the present invention is a playing method of a slot machine comprising the steps of: betting a credit; determining a slot game area to be activated according to the bet among a plurality of slot game areas in order to execute a slot game of rearranging arranged symbols; executing the slot game in the activated slot game area; and producing, when a winning combination awarding a payout is formed in any of the plurality of slot game areas, an enhanced display of the slot game area in which the winning combination is formed on the display and a sub display different from the display.

The gist of a tenth aspect of the present invention is that the playing method of a slot machine further comprises the step of producing, when a winning combination awarding a payout is formed in a plurality of slot game areas among the slot game areas, an enhanced display of each of the plurality of slot game areas in which the winning combination is formed sequentially on the display and the sub display.

The gist of an eleventh aspect of the present invention is a playing method of a slot machine comprising the steps of: betting a credit; determining a slot game area to be activated according to the bet among a plurality of slot game areas in order to execute a slot game of rearranging arranged symbols; executing the slot game in the activated slot game area; deleting, when a winning combination awarding a payout is formed in any of the plurality of slot game areas, the slot game area displayed on the display and in which the winning combination is formed from the display; and producing an enhanced display of the slot game area in which the winning combination is formed on a sub display different from the display.

The gist of a twelfth aspect of the present invention is that the playing method of a slot machine further comprises the step of producing, when a winning combination awarding a payout is formed in a plurality of slot game areas among the slot game areas, an enhanced display of each of the plurality of slot game areas in which the winning combination is formed sequentially on the sub display.

### BRIEF DESCRIPTION OF THE DRAWINGS

FIG. 1 is a screen displayed on a liquid crystal display of a slot machine according to an embodiment of the present invention, and is an explanatory diagram showing a screen in which an enhanced display of one of a plurality of slot game areas is produced.

FIG. 2 is a perspective view of a slot machine according to an embodiment of the present invention.

FIG. 3 is a block diagram showing a control circuit of the slot machine according to an embodiment of the present invention.

FIG. 4 is a flowchart showing a processing procedure of the slot machine according to an embodiment of the present invention.

FIG. 5 is a flowchart showing a processing procedure of the slot machine according to an embodiment of the present invention.

FIG. 6 is a flowchart showing a processing procedure of the slot machine according to an embodiment of the present invention.

FIG. 7 is a flowchart showing a processing procedure of the slot machine according to an embodiment of the present invention.

FIG. 8 is a flowchart showing a processing procedure of the slot machine according to an embodiment of the present invention.

FIG. 9 is a flowchart showing a processing procedure of the slot machine according to an embodiment of the present invention.

FIG. 10 is a flowchart showing a processing procedure of the slot machine according to an embodiment of the present invention.

FIG. 11 is an explanatory diagram showing each slot game area of the slot machine according to an embodiment of the present invention.

FIG. 12 is an explanatory diagram showing paylines in each slot game area of the slot machine according to an embodiment of the present invention.

FIG. 13 is an explanatory diagram showing a relationship between winning combinations and payouts of the slot machine according to an embodiment of the present invention.

FIG. 14 is an explanatory diagram showing each slot game area displayed on a liquid crystal display of the slot machine according to an embodiment of the present invention.

FIG. 15 is an explanatory diagram showing each slot game area displayed on the liquid crystal display of the slot machine according to an embodiment of the present invention.

FIG. 16 is an explanatory diagram showing each slot game area displayed on the liquid crystal display of the slot machine according to an embodiment of the present invention.

FIG. 17 is an explanatory diagram showing a relationship between the numbers of bet credits and bet areas of the slot machine according to an embodiment of the present invention.

FIG. 18 is a flowchart showing a processing procedure of a slot machine according to a first variation of the present invention.

FIG. 19 is a screen displayed on a liquid crystal display of the slot machine according to the first variation of the present invention, and is an explanatory diagram showing a screen in which an enhanced display of one of a plurality of slot game areas is produced.

FIG. 20 is a flowchart showing a processing procedure of a slot machine according to a second variation of the present invention.

FIG. 21 is a screen displayed on an upper display of the slot machine according to the second variation of the present invention, and is an explanatory diagram showing a screen in which an enhanced display of one of a plurality of slot game areas is produced.

FIG. 22 is a flowchart showing a processing procedure of a slot machine according to a third variation of the present invention.

FIG. 23 is a screen displayed on an upper display of the slot machine according to the third variation of the present invention, and is an explanatory diagram showing a screen in which an enhanced display of one of a plurality of slot game areas is produced.

FIG. 24 is a flowchart showing a processing procedure of a slot machine according to a fourth variation of the present invention.

FIG. 25 is an explanatory diagram showing a screen displayed on a liquid crystal display when a payout is awarded in the slot machine according to the fourth variation of the present invention.

FIG. 26 is a flowchart showing a processing procedure of a slot machine according to a fifth variation of the present invention.

FIG. 27 is an explanatory diagram showing a screen displayed on a liquid crystal display when a payout is awarded in the slot machine according to the fifth variation of the present invention.

### DETAILED DESCRIPTION OF THE EMBODIMENT

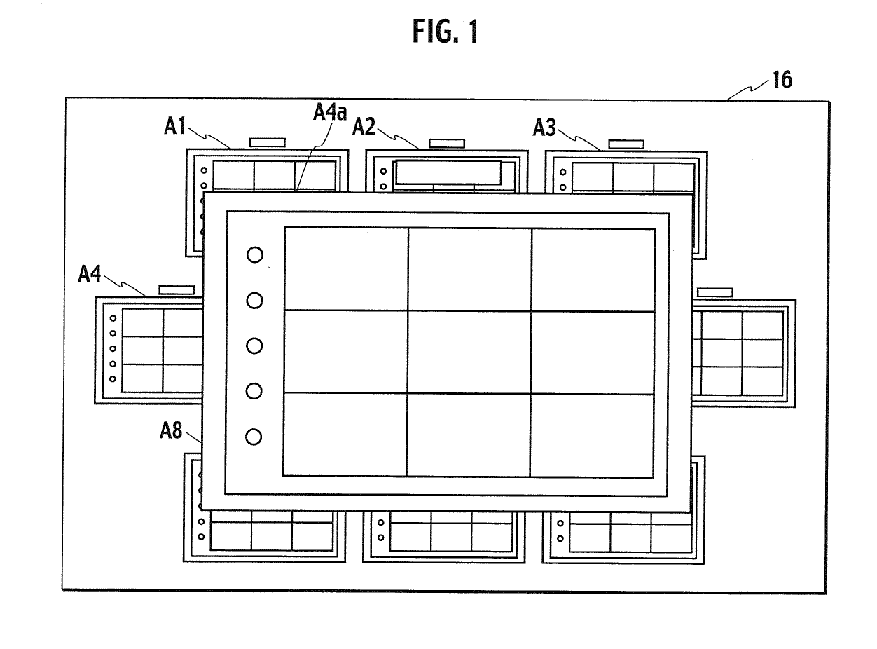

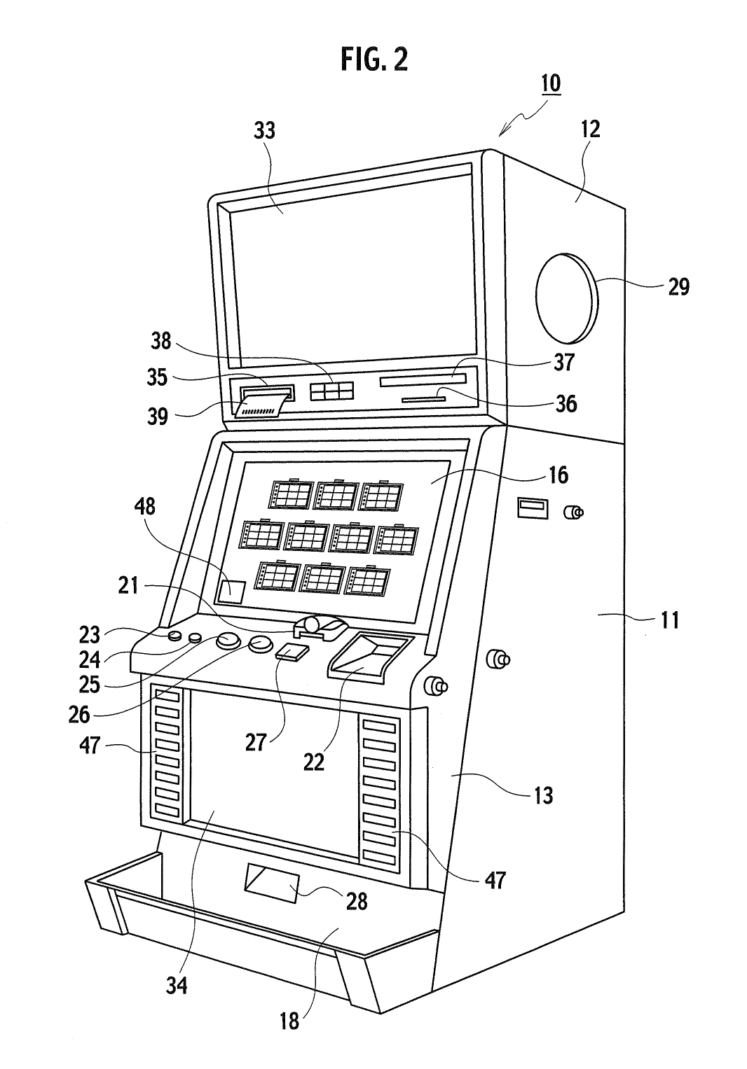

Characteristic parts in the embodiments of the present invention will be described below with reference to a display example shown in FIG. 1 and a perspective view of a slot machine 10 shown in FIG. 2. FIG. 1 is an explanatory diagram showing a display example displayed on a liquid crystal display (display) 16 of the slot machine 10 according to an embodiment of the present invention. On the liquid crystal display 16, ten slot game areas A1 to A10 (hereinafter, simply referred to as “areas”) are provided and a slot game is executed in each of the areas A1 to A10. When a winning combination awarding a payout is formed in any of the areas A1 to A10, an enhanced display of the slot game area in which the winning combination is formed is produced on the liquid crystal display 16.

In other words, in each of the areas A1 to A10, display areas of three rows and three columns, that is, nine display areas in total, are set and when a medal(s) is inserted or a bet switch 25 is pressed, a credit(s) is bet and further when a start switch 27 is pressed, a slot game is executed, in which symbols displayed (arranged) in each of the display areas are scrolled and then the scrolled symbols stop (rearranged) in the display areas of three rows and three columns.

In addition, in the slot game executed in each of the areas A1 to A10, credits corresponding to three medals at the maximum can be bet and in each slot game, the number of paylines increases with the increasing number of bets.

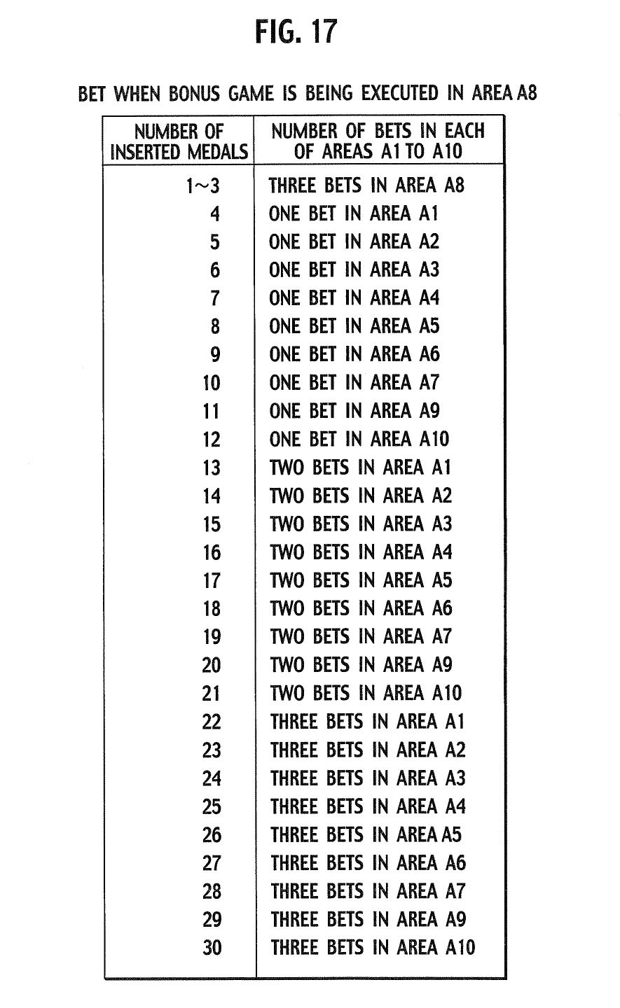

Further, when a medal(s) is inserted through a medal insertion slot (input device) 21 or when the bet switch 25 is pressed, credits are bet sequentially on the ten areas A1 to A10. For example, when a medal is inserted into the medal insertion slot 21, a credit corresponding to one medal is bet on the area A1 and when the second medal is inserted, a credit corresponding to one medal is bet on the area A2. However, as will be described later, a credit is bet preferentially on an area in which a bonus game is being executed. One example of a relationship between the number of inserted medals and the number of bets is shown in FIG. 17 and its details will be described later.

In another embodiment, when a medal(s) is inserted, a credit(s) is bet randomly on each of the areas A1 to A10.

As a result of the execution of the slot game in each of the areas A1 to A10, when symbols forming a winning combination stop on a payline, an enhanced display of the slot game area in which the winning combination is formed is produced on the liquid crystal display 16. In the example shown in FIG. 1, an area A4a, which is an enlarged view of the area A4 in which a winning combination is formed, is displayed at the front of the screen of the liquid crystal display 16 on which each of the areas A1 to A10 is displayed.

Further, the medals in the number corresponding to the winning combination are paid out or the credits in the number corresponding to the winning combination are added. With such a configuration, in the slot machine of the present invention, it is possible to execute a plurality of slot games simultaneously.

In the above, an example is taken and described, in which symbols at rest are scrolled and then the symbols are caused to stop again in each slot game, however, the slot game is not limited to scrolling symbols. For example, symbols displayed (arranged) in each of the display areas may change into another individually and a new symbol may be displayed (rearranged) instead.

Further, in the above, the maximum number of credits that can be bet on each of the areas A1 to A10 is three, however, the present invention is not limited to this.

Further, in the above, as an enhanced display, an area in which a winning combination is formed is enlarged and displayed at the front of the screen, however, the present invention is not limited to this. Enhanced displays include a variety of forms, such as, for example, a flashing display of the entire area, a flashing display of the frame of an area, and a display of animation.

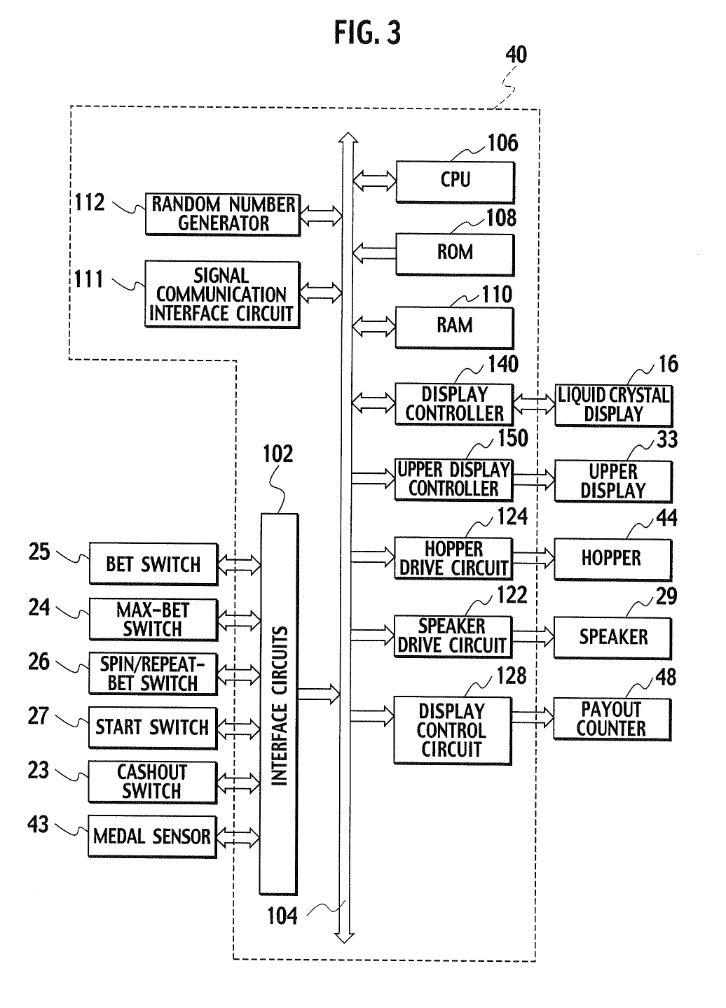

FIG. 2 is a perspective view showing the slot machine 10 according to the embodiment of the present invention. The slot machine 10 includes a cabinet 11, a top box 12 provided on the upper side of the cabinet, and a main door 13. On the surface of cabinet 11 that faces a player, the liquid crystal display 16 is provided. In addition, inside the cabinet 11, various constituent members are provided, including a controller 40 (see FIG. 3) for electrically controlling the slot machine 10, a hopper 44 (see FIG. 3) for controlling the insertion, storage, and payout of a medal(s), etc.

In the present embodiment, a medal as a gaming medium used to execute a game is taken as an example. However, the gaming medium is not limited to the medal, and for example, coins, tokens, electric money, or electronic value information (credit) equivalent to those may be used.

The main door 13 is attached so that it can be opened and closed on the cabinet 11 and in substantially the center of the main door 13, the liquid crystal display 16 is provided. As will be described later, on the liquid crystal display 16, the ten slot game areas A1 to A10 (hereinafter, simply referred to as “areas”) are provided and in each of the areas A1 to A10, the slot game is executed independently. In the present embodiment, the number of slot game areas is “ten”, however, the present invention is not limited to this as long as two or more slot game areas are present.

In each of the areas A1 to A10, display areas of three rows and three columns, that is, nine display areas in total, are provided and various symbols are displayed in each of the display areas. In other words, when the slot game is started, the symbols displayed (arranged) in each of the display areas are scrolled and after a lapse of a predetermined time, the symbols stop (rearranged). Then, a payout is awarded according to a combination of the symbols that stop in each of the display areas. When a payout is awarded, an enhanced display of the area in which a payout is awarded is produced on the liquid crystal display 16.

In the bottom-left area of the liquid crystal display 16, a payout counter 48 for displaying the number of payouts is provided.

Below the liquid crystal display 16, the medal insertion slot 21 through which a medal(s) used to play a game is inserted and a bill validator 22 for validating bills and accepting valid ones are provided. In the vicinity of the medal insertion slot 21 and the bill validator 22, various operational switches are provided.

As the operation switches, a cashout switch 23, a max-bet switch 24, the bet switch 25, a spin/repeat-bet switch 26, and the start switch 27 are provided.

The bet switch 25 is a switch for determining the number of credits to be bet on each slot game executed in the plurality of the slot game areas A1 to A10 and, as will be described later, each time the bet switch 25 is pressed, a credit corresponding to one medal is bet on each of the slot game areas A1 to A10. In the slot game areas A1 to A10 on which a credit(s) is bet, the slot game executed therein is activated and when symbols forming a winning combination stop on the payline, a payout is awarded.

The spin/repeat-bet switch 26 is a switch for betting a credit(s) again on each of the areas A1 to A10 and executing the slot game in each of the areas A1 to A10 without changing the number of credits bet by the bet switch 25 in a previous game.

The start switch 27 is a switch for starting the slot game in each of the slot game areas A1 to A10 after the betting of a desired number of credits on the plurality of the slot game areas A1 to A10. After a medal(s) is inserted into the medal insertion slot 21 or a credit (s) is bet by the bet switch 25, when the start switch 27 is pressed, the slot game is started in each of the areas A1 to A10.

The cashout switch 23 is a switch for paying out the inserted medal(s) and the medal(s) to be paid out is ejected from a medal cashout chute 28 opened in the front lower side of the main door 13 and the paid out medal (s) is pooled in a medal tray 18.

The max-bet switch 24 is a switch for betting the maximum number of credits (e.g., 30 medals) that can be bet on a single game by one operation.

On the lower front side of the main door 13, a foot display 34 is provided, on which various images relating to the game of the slot machine 10 are displayed. Such images include, for example, characters of the slot machine 10 etc.

On both sides of the foot display 34, lamps 47 are provided, which emit light based on a preset light emission pattern for the play of the slot machine 10. On the lower side of the foot display 34, the medal cashout chute 28 is provided.

On the front side of the top box 12, an upper display (sub display) 33 is provided. The upper display 33 includes a display panel and on which the number of medals to be paid out for a combination of symbols etc. is displayed.

The top box 12 is also provided with a speaker 29. On the lower side of the upper display 33, a ticket printer 35, a card reader 36, a data display 37, and a keypad 38 are provided. The ticket printer 35 prints out bar code into which the number of credits, time and date, identification number of the slot machine 10, etc., have been encoded on a ticket and outputs it as a bar-coded ticket 39.

The player can have another slot machine read the bar-coded ticket 39 to play a game thereon and exchange the bar-coded ticket 39 for bills at a predetermined site in an amusement facility (e.g., a cashier in the casino).

A smart card can be inserted into the card reader 36 and the card reader 36 reads data from the smart card and writes data onto the smart card. The smart card is carried by the player and the smart card stores the player's identification data and data relating to the history of the games played by the player.

FIG. 3 is a block diagram showing an electrical configuration of the controller 40 and various devices connected to the controller 40 provided in the slot machine 10 according to the present embodiment. The controller 40 of the slot machine 10 shown in FIG. 3 is a microcomputer and includes interface circuits 102, an I/O bus 104, a CPU 106, a ROM 108, a RAM 110, a signal communication interface (I/F) circuit 111, a random number generator 112, a speaker drive circuit 122, a hopper drive circuit 124, a display drive circuit 128, a display controller 140 and an upper display controller 150.

The interface circuits 102 are connected to the I/O bus 104 and the I/O bus 104 executes input and output of data signals and address signals with the CPU 106.

To the interface circuits 102, the start switch 27 is connected. The start signal output from the start switch 27 is transmitted to the CPU 106 via the I/O bus 104, after having been converted into a predetermined signal by the interface circuits 102.

Further, to the interface circuits 102, the bet switch 25, the max-bet switch 24, the spin/repeat-bet switch 26, and the cashout switch 23 are connected. Then, each of the switching signals output from each of the switches 23 to 26 is supplied to the interface circuits 102 and then transmitted to the CPU 106 via the I/O bus 104, after having been converted into a predetermined signal by the interface circuits 102.

In addition, to the interface circuits 102, a medal sensor 43 is connected. The medal sensor 43 is a sensor for detecting medals, which have been inserted into the medal insertion slot 21, and provided at the portion of the medal insertion slot 21 where a medal(s) is inserted. The detection signal output from the medal sensor 43 is supplied to the interface circuits 102 and then transmitted to the CPU 106 via the I/O bus 104, after having been converted into a predetermined signal by the interface circuits 102.

To the I/O bus 104, the ROM 108 that stores the system program and the RAM 110 for storing various data are connected. Further, to the I/O bus 104, the random number generator 112, the signal communication (I/F) circuit 111, the display controller 140, the hopper drive circuit 124, the speaker drive circuit 122, and the display drive circuit 128 are connected.

The CPU 106, triggered by receiving the start operation of the game from the start switch 27, reads a game execution program and executes a game. The game execution program is a program for executing the slot game in each of the areas A1 to A10 provided on the liquid crystal display 16 via the display controller 140.

In other words, the game execution program is programmed so as to execute a slot game in which symbols are caused to come to a stop after being scrolled in each of the display areas A1 to A10 and a payout will be awarded when the symbols having stopped form a winning combination on the activated payline.

The signal communication I/F circuit 111, which is connected to a hall server etc., transmits history data etc. of the plays executed in the slot machine 10 to the hall server. In addition, the signal communication I/F circuit 111 receives various data transmitted from the hall server.

The random number generator 112 generates a random number for determining whether or not to form a winning combination in the slot game executed in each of the areas A1 to A10.

The display drive circuit 128 controls a display of the number of payouts in the payout counter 48 set in the bottom-left area of the liquid crystal display 16.

The speaker drive circuit 122 outputs audio data to the speakers 29. In other words, the CPU 106 reads the audio data stored in the ROM 108 and transmits the audio data to the speaker drive circuit 122 via the I/O bus 104. In this manner, predetermined sound effects are output from the speakers 29.

The hopper drive circuit 124 outputs a payout signal to the hopper 44 when providing a cashout. In other words, when the cashout signal is input by the cashout switch 23, the CPU 106 outputs a drive signal to the hopper drive circuit 124 via the I/O bus 104. As a result, the hopper 44 pays out medals equivalent to the remaining credits stored in a predetermined memory area of the RAM 110.

The display controller 140 controls a display of the slot game executed in the plurality of the areas A1 to A10 provided on the liquid crystal display 16. In other words, the CPU 106 generates an image display command signal according to the progress and outcome of the slot game for each of the areas A1 to A10 and outputs the image display command signal to the display controller 140 via the I/O bus 104. When the image display command signal output from the CPU 106 is input, the display controller 140 generates a drive signal to drive the liquid crystal display 16 based on the image display command and outputs the generated drive signal to the liquid crystal display 16. In this manner, predetermined images are displayed on the liquid crystal display 16.

The upper display controller 150 controls the screen display of the upper display 33. In other words, the CPU 106 generates an image display command signal according to the progress and outcome of the slot game and outputs the image display command signal to the upper display controller 150 via the I/O bus 104. When the image display command signal output from the CPU 106 is input, the upper display controller 150 generates a drive signal to drive the upper display 33 based on the image display command and outputs the generated drive signal to the upper display 33. In this manner, predetermined images are displayed on the upper display 33.

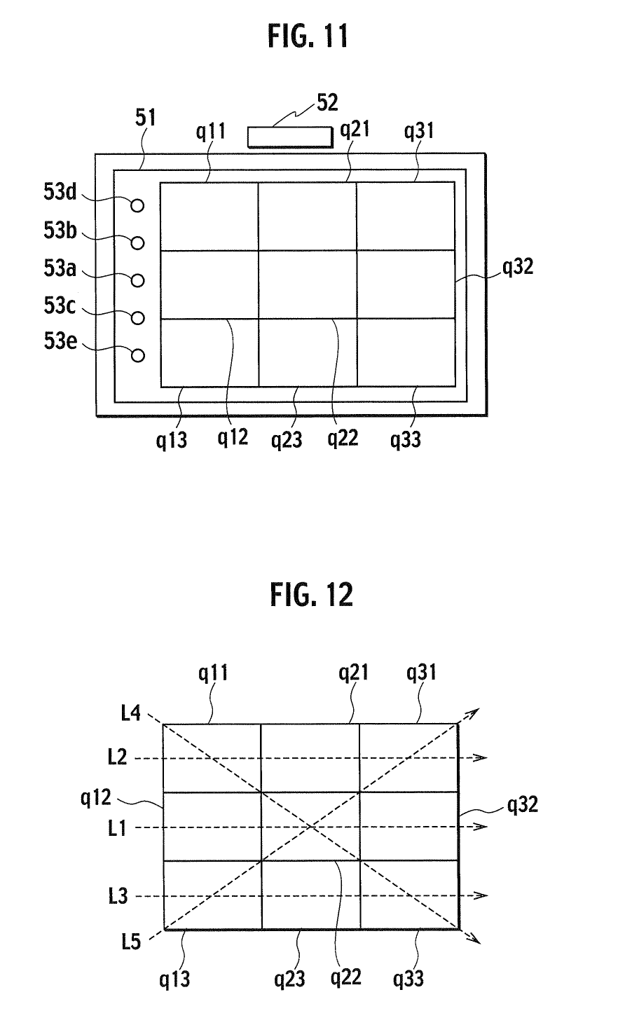

Next, images displayed in each of the slot game areas A1 to A10 are described with reference to FIG. 11. FIG. 11 is a display example of each of the areas A1 to A10.

As shown in FIG. 11, in each of the areas A1 to A10, display areas q11 to q33 of three rows and three columns, that is, nine display areas in total, are provided and when the slot game is executed, various symbols are scrolled in the nine display areas q11 to q33.

On the left-hand side of each of the display areas q11 to q33, five LEDs 53a to 53e are provided and each of the LEDs 53a to 53e lights up according to the number of bets. In detail, when a credit equivalent to one medal is bet on the slot game area, the LED 53a lights up, when credits equivalent to two medals are bet on the slot game area, the LEDs 53b, 53c, in addition to the LED 53a, light up, and when credits equivalent to three medals are bet on the slot game area, the LEDs 53d, 53e, in addition to the LEDs 53a to 53c, light up.

Each of the LEDs 53a to 53e is provided in order to notify the payline in the slot game area. FIG. 12 is an explanatory diagram showing the payline in the slot game area and on the nine in total display areas q11 to q33 of three rows and three columns, a transverse line in the middle row is set to L1, a transverse line in the upper row is set to L2, and a transverse line in the lower row is set to L3. Further, an oblique line descending rightward is set to L4 and an oblique line ascending rightward is set to L5.

When the LED 53a shown in FIG. 11 is lit, the line L1 is set as a payline and when the LEDs 53b, 53c are lit, the lines L2, L3 are set as a payline, and further, when the LEDs 53d, 53e are lit, the lines L4, L5 are set as a payline. As a result, when a credit equivalent to one medal is bet, only the line L1 is the payline, when credits equivalent to two medals are bet, the lines L1, L2, and L3 are the paylines, and when credits equivalent to three medals are bet, all of the lines L1 to L5 are the paylines. Then, when symbols forming a winning combination stop on the payline, a payout is awarded according to the winning combination.

Around each of the display areas q11 to q33, an activated area notifying frame 51 is provided and the activated area notifying frame 51 lights up when the slot game area is activated. When at least a credit equivalent to one medal is bet on the slot game area, the activated area notifying frame 51 in the slot game area lights up. Due to this, it is possible for a player to easily recognize the activated area among the ten areas A1 to A10.

Above each of the display areas q11 to q33, a bonus notifying part 52 is provided and the bonus notifying part 52 lights up when a bonus game (to be described later) is being executed in the slot game executed in the slot game area. It is possible for a player to recognize the area in which the bonus game is being executed by confirming the bonus notifying part 52.

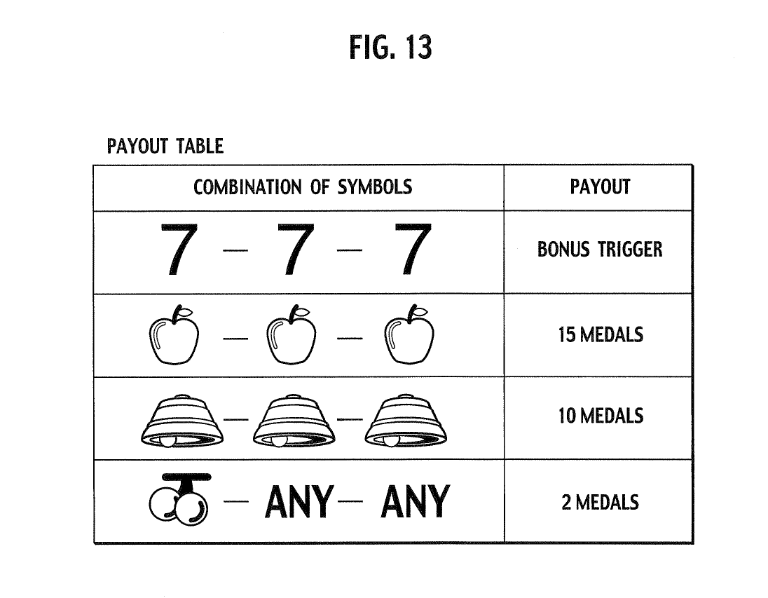

FIG. 13 is an explanatory diagram showing the arrangement of symbols that form a winning combination. As shown in FIG. 13, when the symbols 171 are rearranged on the payline, for example, when the line L1 is set to the payline as shown in FIG. 12 and if the three symbols 11711 are arranged on the payline, the bonus game is started. Further, when the “APPLE” symbols are rearranged, a payout of 15 medals is awarded, when the “BELL” symbols are rearranged, a payout of ten medals is awarded, and when the “CHERRY” symbol stops on the left-hand display area, a payout of two medals is awarded.

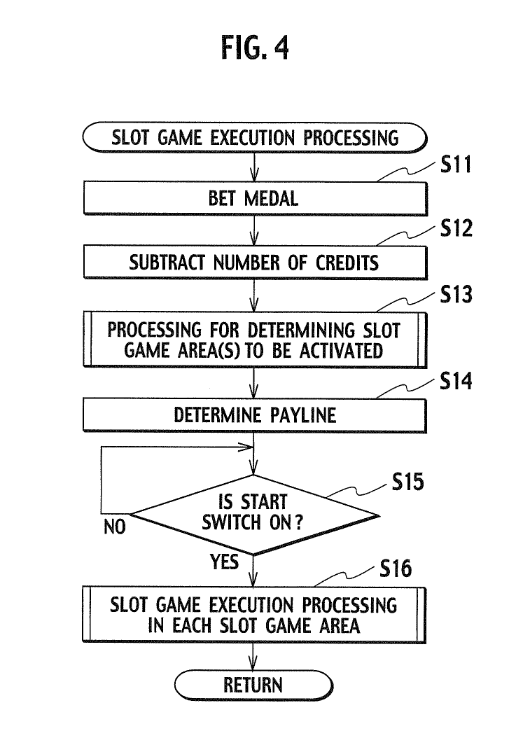

Next, the operation of the slot machine according to the present embodiment is described with reference to flowcharts shown in FIG. 4 to FIG. 10. FIG. 4 is a flowchart showing the slot game execution processing.

First, a player presses the bet switch 25 and bets a desired number of credits (step S11). Alternatively, the player inserts a desired number of medals through the medal insertion slot 21 and bets credits equivalent to the number of inserted medals. The CPU 106 shown in FIG. 3 subtracts the bet credits from the current credits when the credits are bet by pressing the bet switch 25 (step S12). For example, when the number of credits is “50” and “30” credits are bet, the remaining credits will be “20” by the subtraction of “30” credits.

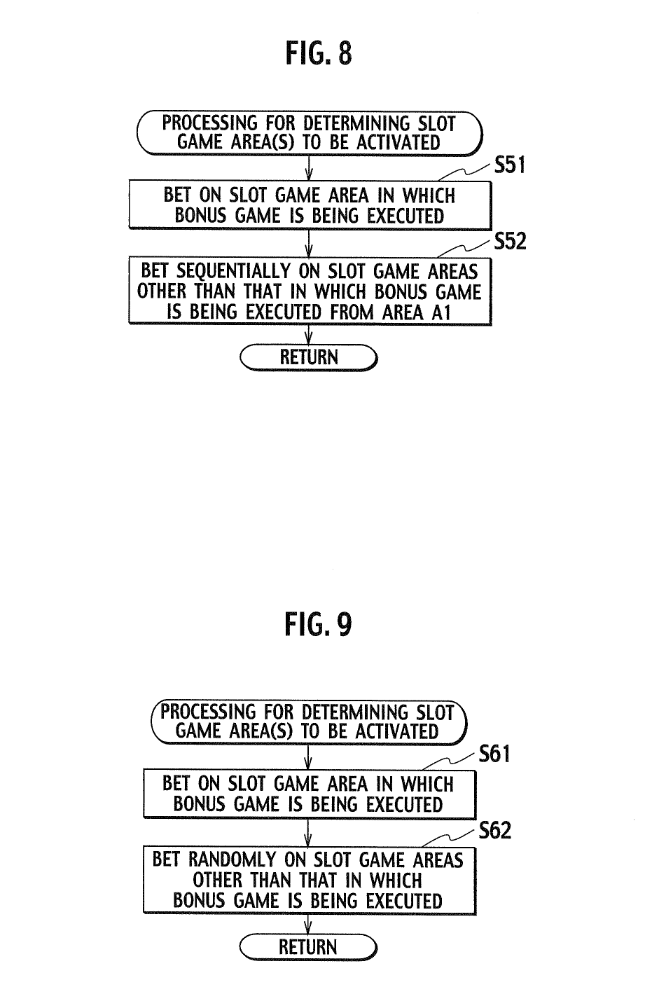

Next, the CPU 106 determines areas to be activated among the ten in total slot game areas A1 to A10 (step S13). The details of the processing will be described later using FIG. 8, FIG. 9.

When the processing for determining areas to be activated is completed, the CPU 106 determines a payline in the activated areas (step S14). As described above, in the processing, when a credit equivalent to one medal is bet on one area, the line L1 shown in FIG. 12 is activated, when credits equivalent to two medals are bet on one area, the lines L1, L2, and L3 are activated, and when credits equivalent to three medals are bet on one area, all of the lines L1 to L5 are activated. In the areas A1 to A10 on which a credit(s) is bet, the activated area notifying frame 51 provided therearound lights up to notify the player of the activated area(s).

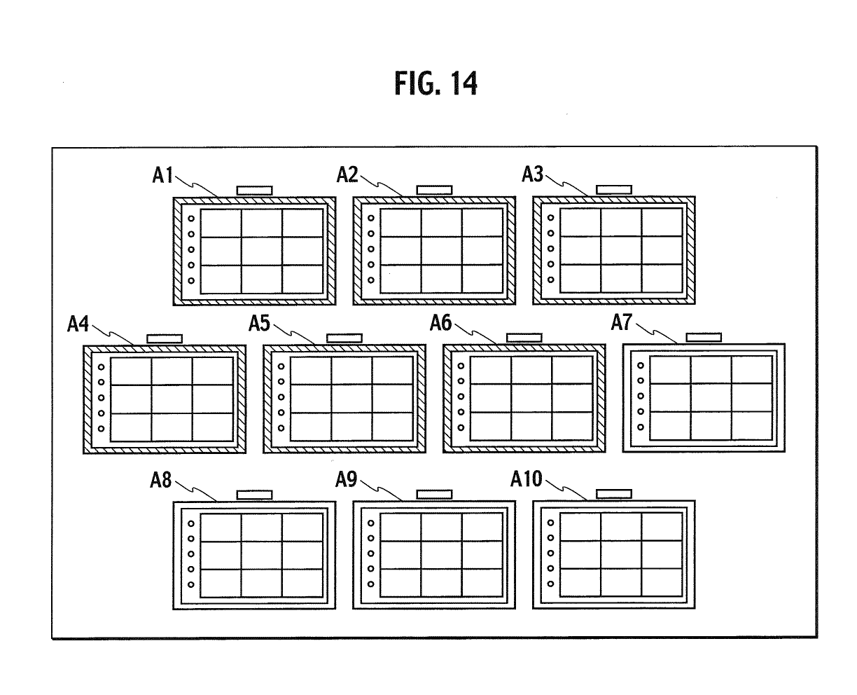

For example, when the areas A1 to A6 are activated, the activated area notifying frame 51 in each of the areas A1 to A6 lights up and the activated area notifying frame 51 does not light up in each of the areas A7 to A10 not activated, as shown in FIG. 14.

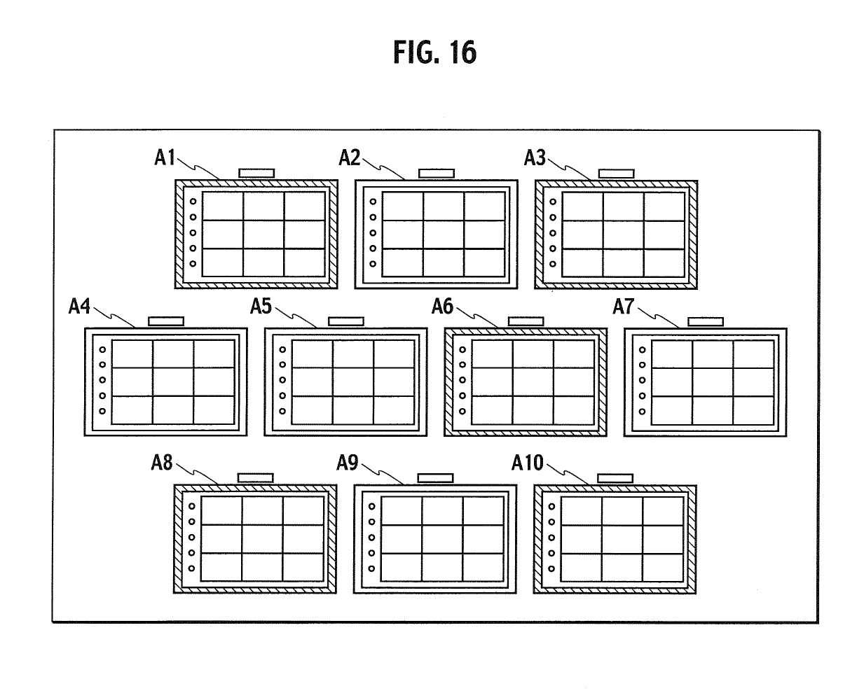

As will be described later, when a credit(s) is bet randomly on each of the areas A1 to A10, the credit(s) is not necessarily bet in the order from A1 to A10. As a result, for example, the areas A1, A3, A6, A8, A10 may be activated randomly as shown in FIG. 16 and the activated area notifying frame 51 lights up in each of these areas.

After that, the CPU 106 determines whether or not the start switch 27 has been turned on (step S15) and when it is determined that the start switch 27 has been turned on, the CPU 106 executes the slot game in each of the areas A1 to A10 (step S16).

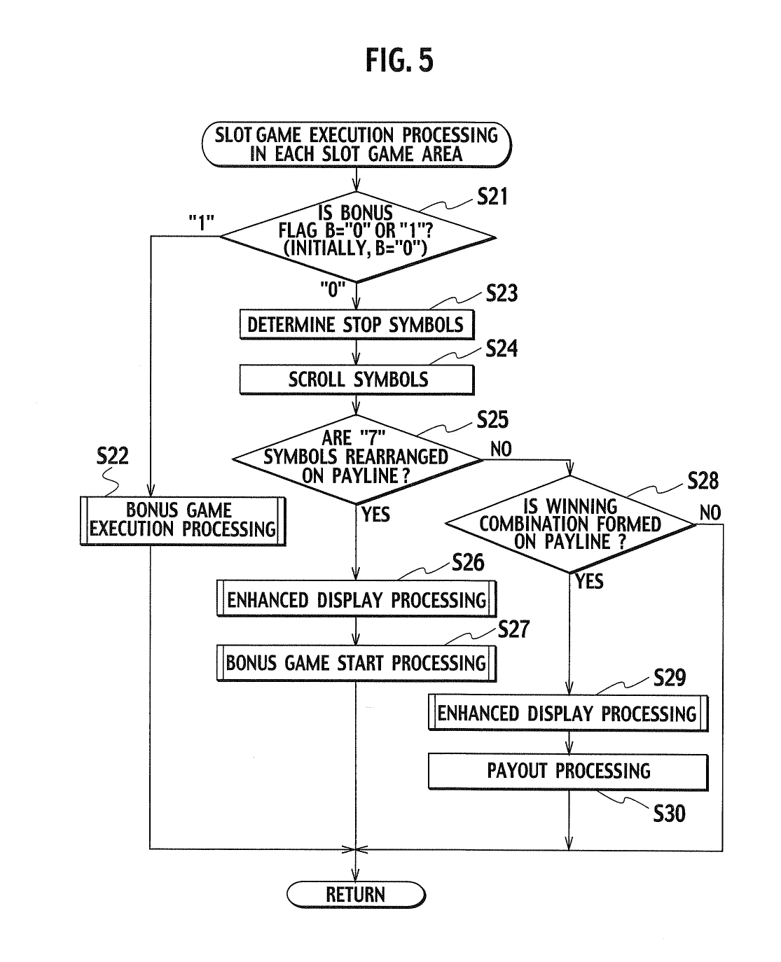

Next, with reference to FIG. 5, the processing procedure of the slot game executed in each of the areas A1 to A10 is described. Here, the slot game typically executed in the area A1 is described.

First, the CPU 106 determines whether the bonus flag is “0” or “1” in the area A1 (step S21). The bonus flag is set to “1” when the bonus game is executed and is initially “0”.

Next, the CPU 106 determines symbols to be stopped in each of the display areas q11 to q33 in the area A1 (step S23). By this processing, symbols (“7”, “BELL”, “APPLE”, etc.) to be displayed in each of the display areas q11 to q33 are determined.

After that, the CPU 106 scrolls the symbols in each of the display areas q11 to q33 in the area A1 (step S24). Then, after a lapse of a predetermined time, the symbols stop in each of the display areas q11 to q33. The symbols that stop at this time are those determined in step S23.

Then, the CPU 106 determines whether or not the symbol “7” indicative of the bonus trigger has been rearranged on the payline (step S25). For example, when all of the five lines L1 to L5 shown in FIG. 12 are set to the payline, the CPU 106 determines whether or not the symbol “7” has been rearranged on any of the paylines L1 to L5.

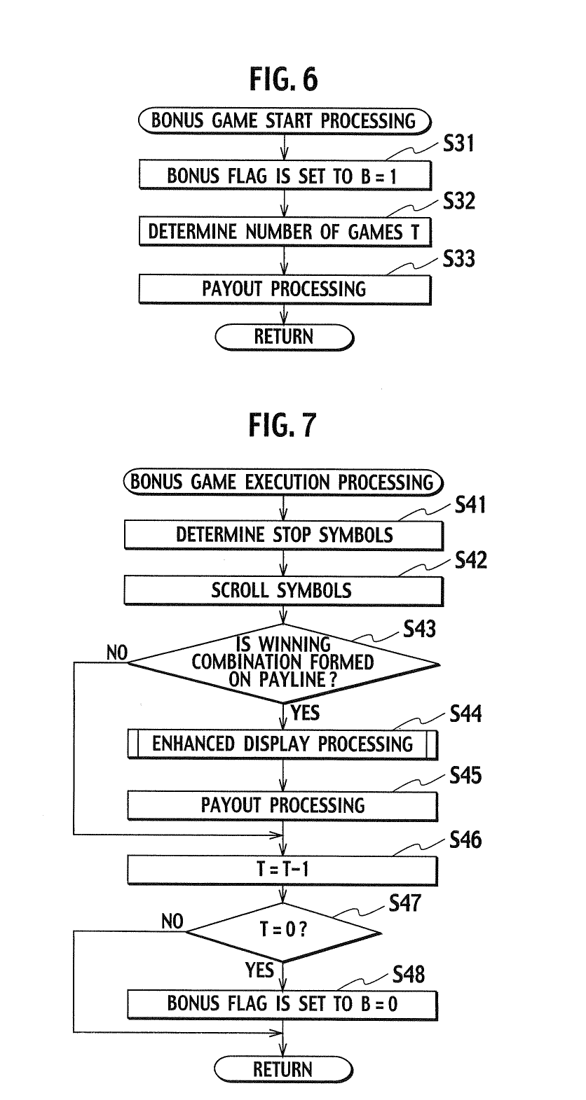

When the symbol “7” is rearranged on any of the paylines L1 to L5, a bonus trigger is formed and the CPU 106 executes the bonus game start processing (step S27) as well as executing enhanced display processing to be described later (step S26). The bonus game start processing is described later in FIG. 6.

When the symbols “7” has not been rearranged on the payline, the CPU 106 determines whether or not symbols forming a winning combination have been rearranged on the payline (step S28) and when symbols forming a winning combination have been rearranged, the CPU 106 causes a payout of the number of medals to be awarded according to the winning combination (step S30) as well as executing the enhanced display processing to be described later (step S29). When the symbols forming a winning combination have not been rearranged on the payline, the CPU 106 does not cause a payout to be awarded but ends the slot game in the area A1. When a payout is awarded, it may be possible to pay out a medal (s) equivalent to the payout through the medal cashout chute 28 or to add a credit(s) equivalent to the payout to the current credits.

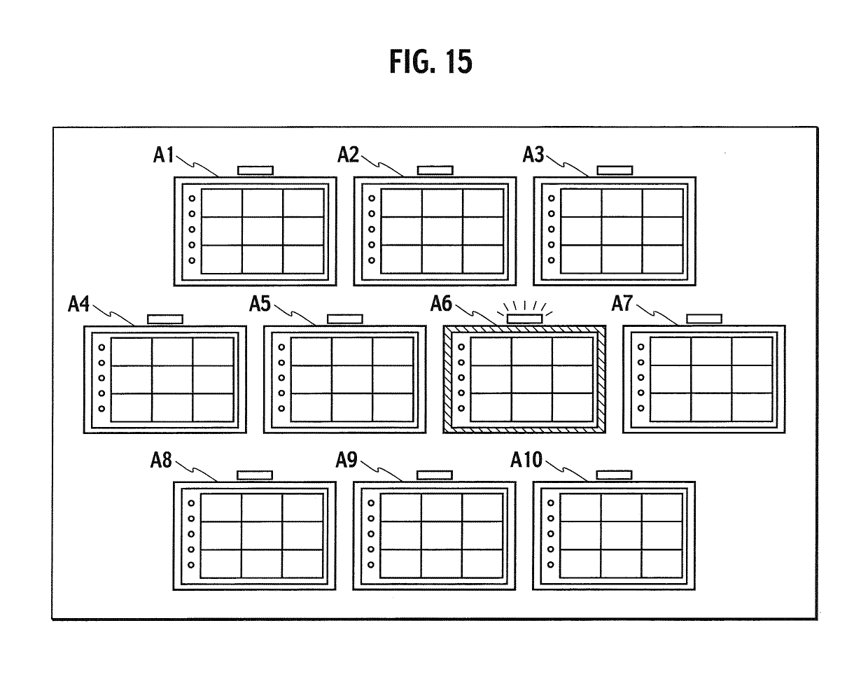

Next, the procedure of bonus game start processing is described with reference to the flowchart shown in FIG. 6. In the processing in step S25 in FIG. 5, when the symbol “7” is rearranged on the payline and the bonus trigger is formed, the bonus flag is set to “1” (step S31 in FIG. 6). At this time, the bonus notifying part 52 shown in FIG. 11 is lit to notify the player that the bonus game is being executed in the area A1. For example, when the bonus game is being executed in the area A6, the bonus notifying part 52 in the area A6 is lit, as shown in FIG. 15.

After that, the CPU 106 determines the number of bonus games T (step S32). The number of games T is, for example, 50, or it may be a fixed number of games at all times, or it may be determined randomly each time by the CPU 106. The number of games “T” is stored in the RAM 110.

Next, a payout is awarded as a result of the formation of the bonus trigger (step S33). In this processing, for example, a payout of 15 medals or a payout of credits equivalent to 15 medals is awarded. Then, the present processing is ended.

When the bonus flag is set to “1” in the bonus game start processing shown in FIG. 6, in the next slot game in the area A1, the bonus flag remains “1” and therefore, the bonus flag is “1” in step S21 in FIG. 5 and the bonus game execution processing is executed (step S22).

The bonus game execution processing is described below with reference to the flowchart shown in FIG. 7. When the bonus game is executed, the CPU 106 executes the processing for determining stop symbols (step S41). The processing is the same as the processing in step S23 shown in FIG. 5. However, in the processing in step S41, it is unlikely that the symbol “7” is rearranged on the payline but the setting is made so that a winning combination is rearranged with high probability. In other words, in the bonus game, the setting is made so that the symbols “BELL”, “APPLE”, “CHERRY” shown in FIG. 13 are more likely to be rearranged on the payline than in the game at normal time.

Next, the CPU 106 starts to scroll symbols (step S42). The processing is the same as that in step S24 in FIG. 5.

Then, the CPU 106 determines whether or not symbols forming a winning combination have been rearranged on the payline (step S43) and when symbols forming a winning combination have been rearranged, the CPU 106 causes a payout of the number to be awarded according to the winning combination (step S45) as well as executing the enhanced display processing to be described later (step S44). When symbols forming a winning combination have not been rearranged on the payline, no payout is caused to be awarded.

After that, the CPU 106 decrements the number of games “T” stored in the RAM 110 to “T−1” (step S46).

The CPU 106 determines whether or not the number of games “T” stored in the RAM 110 is “T=0” (step S47) and when it is “T=0”, the CPU 106 sets the bonus flag to “0” (step S48). In other words, when the number of games determined in advance is played, the CPU 106 sets the bonus flag to “0” and ends the bonus game.

Next, the processing for determining a slot game area(s) to be activated is described with reference to the flowcharts shown in FIG. 8 and FIG. 17.

When the bet switch 25 is pressed or a medal(s) is inserted through the medal insertion slot 21, the CPU 106 first bets a credit(s) preferentially on the area in which the bonus game is being executed (step S51). Then, a credit(s) is bet sequentially in the order of the areas A1, A2, A3, . . . , (step S52).

For example, when the bonus game is being executed in the area A8, the first to third credits are bet on the area A8 as shown in FIG. 17, the fourth credit is bet on the area A1, and the fifth credit is bet on the area A2. Then, the above procedure is repeated sequentially and when 30 credits are bet at the maximum, a state is brought about in which three credits are bet on all of the areas A1 to A10.

In the above, an example is shown, in which the area in which the bonus game is being executed is only the area A8, however, when bonus game is being executed in two or more areas simultaneously, a credit(s) is bet preferentially on each area in which the bonus game is being executed and then a credit(s) is bet on the areas in which the bonus game is not being executed.

FIG. 9 is a flowchart showing another procedure of processing for determining a slot game area(s) to be activated. In the processing, when the bet switch 25 is pressed, the CPU 106 first bets a credit (s) preferentially on the area(s) in which the bonus game is being executed, as in the case of FIG. 8 (step S61). After that, the CPU 106 bets a credit (s) randomly on the areas in which the bonus game is not being executed (step S62). The processing is determined arbitrarily by the CPU 106 and determined randomly for each game.

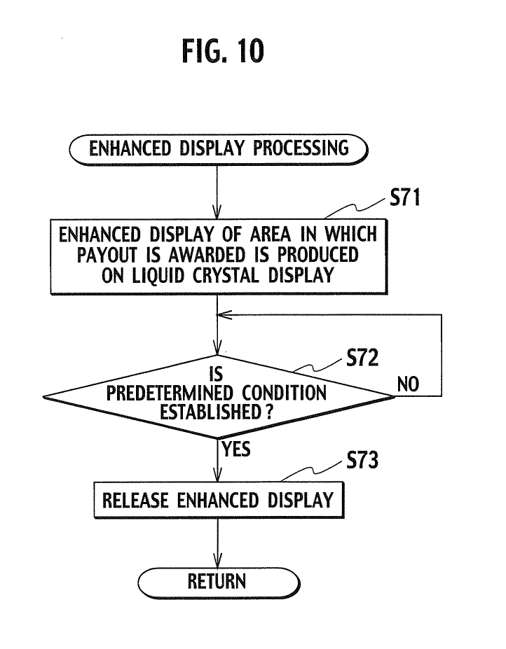

Next, the enhanced display processing of the area(s) in which a payout is awarded is described with reference to the flowchart shown in FIG. 10.

The CPU 106 produces an enhanced display of the area (the area A4 in the example shown in FIG. 1) in which a payout is awarded as shown in FIG. 1 on the liquid crystal display 16 when symbols forming a winning combination are rearranged on the payline and the payout is awarded (step S71). In other words, the CPU 106 generates an image display command signal to produce an enhanced display of the area in which the payout is awarded and inputs it to the display controller 140. When the image display command is input from the CPU 106, the display controller 140 generates a drive signal to drive the liquid crystal display 16 based on the image display command and outputs the generated drive signal to the liquid crystal display 16. Due to this, on the liquid crystal display 16, an image of the enhanced display of the area in which the payout is awarded is displayed. In the example shown in FIG. 1, the area A4a, which is the enlarged view of the area A4 in which a winning combination is formed, is displayed at the front of the screen of the liquid crystal display 16 on which each of the areas A1 to A10 is displayed.

Next, the CPU 106 determines whether or not a predetermined condition has been established (step S72) and when it is determined that the predetermined condition has not been established, the CPU 106 waits for the predetermined condition to be established. Here, the predetermined condition may be a time of enhanced display or the start of the next slot game.

On the other hand, when it is determined that a predetermined condition has been established, the CPU 106 releases the enhanced display produced in step S71 and ends the enhanced display processing (step S72). Specifically, the CPU 106 generates an image display command signal to release the enhanced display of the area in which the payout is awarded and inputs it to the display controller 140. Due to this, on the liquid crystal display 16, the enhanced display is released and a screen on which the normal slot game is executed is displayed.

In this manner, in the slot machine according to the present embodiment, it is possible to execute a plurality of slot games simultaneously in one play by providing a plurality of slot game areas (ten areas in the present embodiment).

In the above embodiment, it is possible to produce an enhanced display of the slot game area in which a payout is awarded even when a plurality of slot game areas is displayed on the liquid crystal display 16 and the slot game in each area is executed simultaneously. Due to this, it is possible for a player to instantaneously recognize in which slot game area a payout is awarded.

Further, it is also possible to enhance the ambience of the game and make a player have a greater desire to play a game by producing an enhanced display of the slot game area in which a payout is awarded.

In the above embodiment, as an enhanced display, the area in which a winning combination is formed is enlarged and displayed at the front of the screen, however, the present invention is not limited to this. For example, enhanced displays include various displays, such as a flashing display of the entire area, a flashing display of the frame of the area, a display of animation, etc.

(First Variation)

In the above embodiment, the case is described, where a payout is awarded only in one slot game area among the plurality of slot game areas, however, in a first variation, a case is described, where a payout is awarded in two or more slot game areas among the slot game areas.

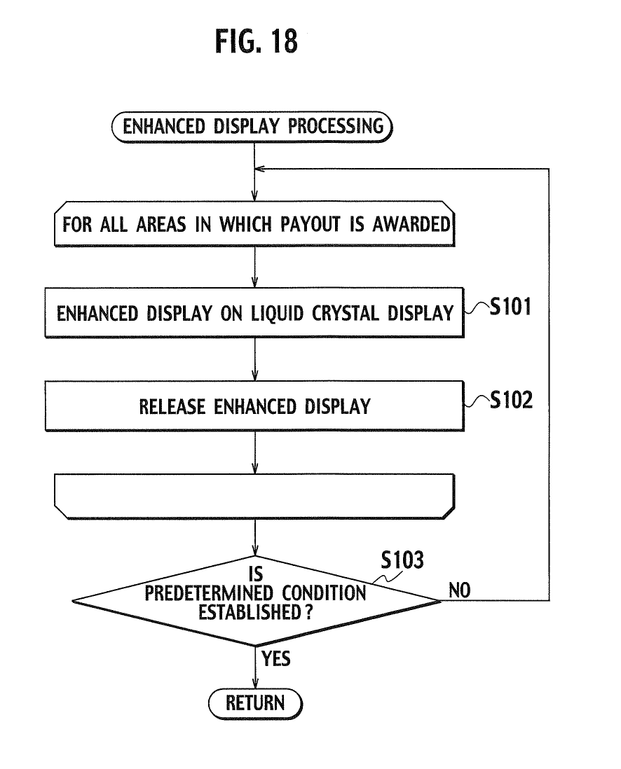

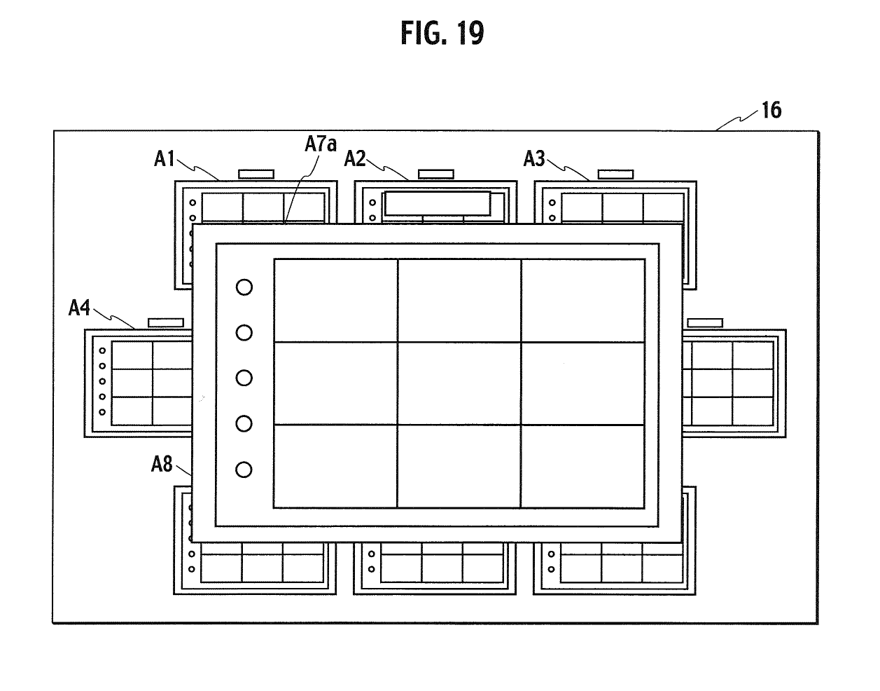

The enhanced display processing of the area in which a payout is awarded is described in the first variation of the present invention with reference to FIG. 1, FIG. 18, and FIG. 19.

As shown in step S16 in FIG. 4, the processing shown in FIG. 5 to FIG. 9 is executed for each of the plurality of slot game areas. When the enhanced display processing is called, the CPU 106 executes the enhanced display processing shown in FIG. 18 for each of the slot game areas in step S26, step S29 in FIG. 5 and in step S44 in FIG. 7.

In the enhanced display processing shown in FIG. 18, the processing in step S101 and step S102 is executed for two or more areas in which symbols forming a winning combination are rearranged on the payline and a payout is awarded among the slot game areas. Here, a case is described, in which a payout is awarded in the slot game area A4 and the slot game area A7.

First, the processing in step S101 and step S102 is executed for the slot game area A4. When symbols forming a winning combination are rearranged on the payline and a payout is awarded, the CPU 106 produces an enhanced display of the area (the area A4) in which a payout is awarded on the liquid crystal display 16 as shown in FIG. 1 (step S101). In other words, the CPU 106 generates an image display command signal to produce an enhanced display of the area in which the payout is awarded and inputs it to the display controller 140. When the image display command is input from the CPU 106, the display controller 140 generates a drive signal to drive the liquid crystal display 16 based on the image display command and outputs the generated drive signal to the liquid crystal display 16. Due to this, on the liquid crystal display 16, an image of the enhanced display of the area in which a payout is awarded is displayed. In the example shown in FIG. 1, the area A4a, which is an enlarged view of the area A4 in which a winning combination is formed, is displayed at the front of the screen of the liquid crystal display 16 on which each of the areas A1 to A10 is displayed.

Further, the CPU 106 releases the enhanced display produced in step S101 (step S102). Specifically, the CPU 106 generates an image display command signal to release the enhanced display of the area in which the payout is awarded and inputs it to the display controller 140. Due to this, on the liquid crystal display 16, the enhanced display is released and a screen on which the normal slot game is executed is displayed.

Next, the CPU 106 executes the processing in step S101 and step S102 for the slot game area A7, which is another area in which a payout is awarded. When symbols forming a winning combination are rearranged on the payline and a payout is awarded, the CPU 106 produces an enhanced display of the area (area A7) in which a payout is awarded on the liquid crystal display 16 as shown in FIG. 19 (step S101). In other words, the CPU 106 generates an image display command signal to produce an enhanced display of the area in which the payout is awarded and inputs it to the display controller 140. When the image display command is input from the CPU 106, the display controller 140 generates a drive signal to drive the liquid crystal display 16 based on the image display command and outputs the generated drive signal to the liquid crystal display 16. Due to this, on the liquid crystal display 16, an image of the enhanced display of the area in which a payout is awarded is displayed. In the example shown in FIG. 18, an area A7a, which is an enlarged view of the area A7 in which a winning combination is formed, is displayed at the front of the screen of the liquid crystal display 16 on which each of the areas A1 to A10 is displayed.

Further, the CPU 106 releases the enhanced display produced in step S101 (step S102). Specifically, the CPU 106 generates an image display command signal to release the enhanced display of the area in which the payout is awarded and inputs it to the display controller 140. Due to this, on the liquid crystal display 16, the enhanced display is released and a screen on which the normal slot game is executed is displayed.

When the processing in step S101 and step S102 ends for all the areas in which a payout is awarded, the CPU 106 determines whether or not a predetermined condition has been established (step S103). When it is determined that the predetermined condition has not been established, the CPU 106 further executes the processing in step S101 and step S102 for all the areas in which a payout is awarded. Here, the predetermined condition may be a time of enhanced display or the start of the next slot game.

On the other hand, when it is determined that the predetermined condition has been established, the CPU 106 ends the enhanced display processing.

In this manner, in the slot machine according to the first variation, it is possible to produce the enhanced displays of the two or more slot game areas in which a payout is awarded sequentially on the liquid crystal display 16 even when a payout is awarded in the two or more slot game areas. Specifically, when a payout is awarded in the area A4 and the area A7, the screen shown in FIG. 1, which is an enlarged view of the area A4, and the screen shown in FIG. 19, which is an enlarged view of the area A7 are displayed sequentially on the liquid crystal display 16. Due to this, it is possible to instantaneously confirm in which slot game area a payout is awarded even if a payout is awarded in two or more slot game areas.

Further, when a payout is awarded in two or more slot game areas, the enhanced displays of the areas in which the payout is awarded are produced sequentially. As a result, the screens to be displayed on the liquid crystal display 16 are deployed one after another, and therefore, it is possible to heighten the joy of a player for a payout and increase the player's desire to play a game.

In the above first variation, as an enhanced display, a display, which is an enlarged view of the area in which a winning combination is formed, is displayed at the front of the screen, however, the present invention is not limited to this. The enhanced displays may include a flashing display of the entire area, a flashing display of the frame of the area, a display of animation, etc.

(Second Variation)

In the above embodiment, the case is described, in which the enhanced display is produced on the liquid crystal display 16 on which the slot game is being executed when a payout is awarded only in the slot game area, however, in a second variation, a case is described, in which an enhanced display is produced on a display different from the liquid crystal display 16 on which the slot game is being executed.

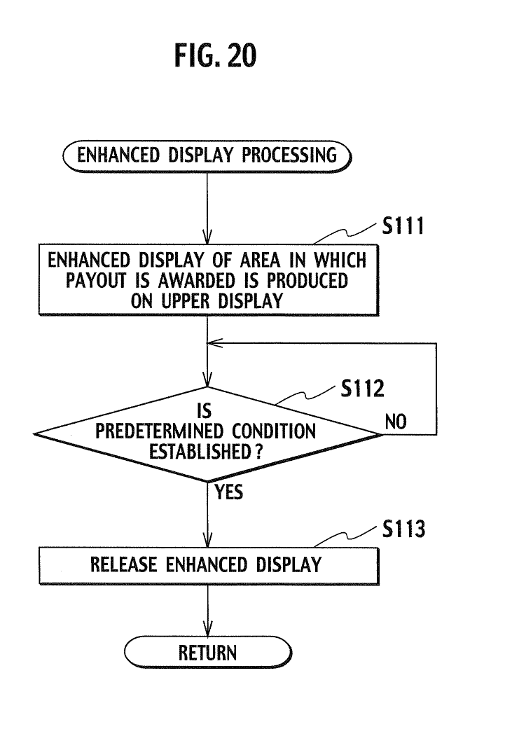

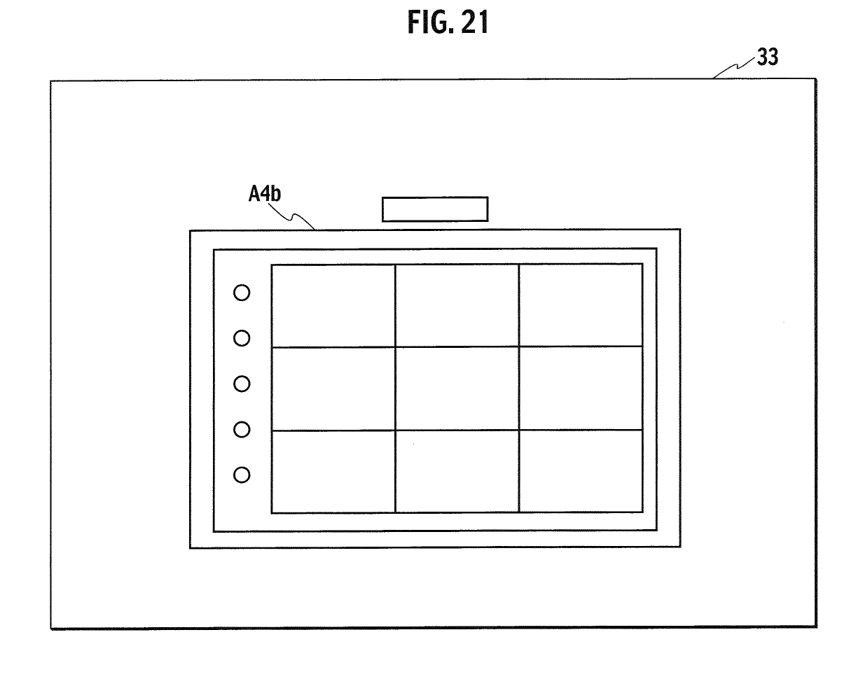

The enhanced display processing of the area in which a payout is awarded is described in the second variation of the present invention with reference to FIG. 20 and FIG. 21. FIG. 20 is a flowchart for describing the enhanced display processing according to the second variation of the present invention.

When symbols forming a winning combination are rearranged on the payline and a payout is awarded, the CPU 106 produces an enhanced display of the area (in the example shown in FIG. 21, the area A4) in which the payout is awarded on the upper display 33, as shown in FIG. 21. In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, an image of the enhanced display of the area in which a payout is awarded is displayed on the upper display 33. In the example shown in FIG. 21, an area A4b, which is an enlarged view of the area A4 in which a winning combination is formed, is displayed on the upper display 33.

Next, the CPU 106 determines whether or not a predetermined condition has been established (step S112) and when it is determined that the predetermined condition has not been established, the CPU 106 waits for the predetermined condition to be established. Here, the predetermined condition may be a time of enhanced display or the start of the next slot game.

On the other hand, when it is determined that the predetermined condition has been established, the CPU 106 releases the enhanced display produced in step S111 and ends the enhanced display processing (step S113). Specifically, the CPU 106 generates an image display command signal to release the enhanced display of the area in which the payout is awarded and inputs it to the upper display controller 150. Due to this, on the upper display 33, the enhanced display is released and a screen when the normal slot game is executed is displayed.

In this manner, in the slot machine according to the second variation, it is possible to produce an enhanced display of the slot game area in which a payout is awarded on the upper display 33 even when two or more slot game areas are displayed on the liquid crystal display 16 and the slot game in each area is executed simultaneously. Due to this, it is possible for a player to instantaneously recognize in which slot game area a payout is awarded.

Further, the enhanced display of the slot game area in which a payout is awarded is produced on the upper display 33, and therefore, it is possible to enhance the ambience of the game and make a player have a greater desire to play a game.

Furthermore, the area in which a payout is awarded is displayed on the upper display 33 different from the liquid crystal display 16 on which the slot game is being executed, and therefore, it is possible to change the player's line of sight. As a result, it is possible to heighten the joy of the player for a payout and make the player have a greater desire to play a game.

In the above embodiment, as an enhanced display, a display, which is an enlarged view of the area in which a winning combination is formed, is displayed on the upper display 33, however, the present invention is not limited to this. The enhanced displays may include a flashing display of the entire area, a flashing display of the frame of the area, a display of animation, etc.

(Third Variation)

In the above embodiment, the case is described, in which a payout is awarded in only one of the two or more slot game areas, however, in a third variation, a case is described, in which a payout is awarded in two or more of the slot game areas.

The enhanced display processing of the area in which a payout is awarded is described in the third variation of the present invention with reference to FIG. 21 to FIG. 23.

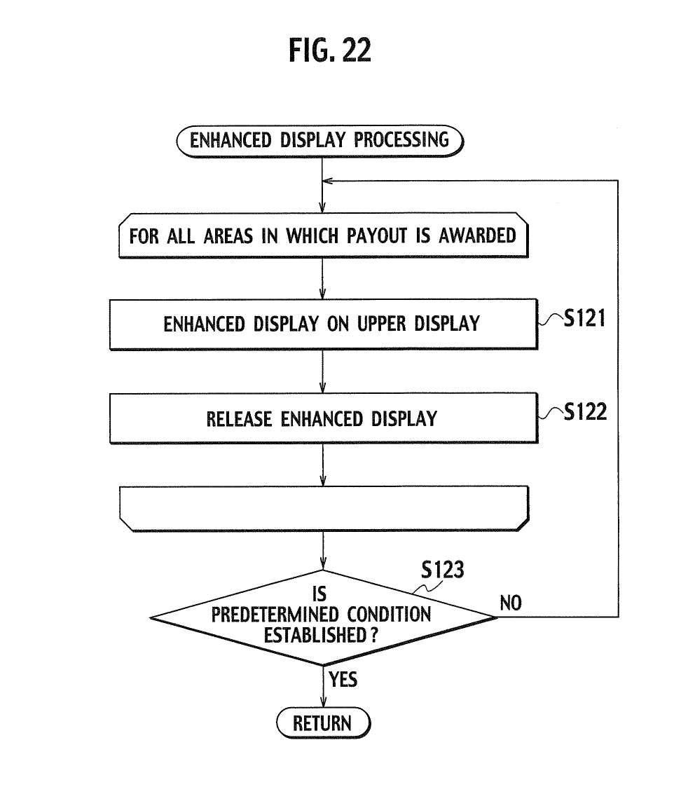

As shown in step S16 in FIG. 4, the processing shown in FIG. 5 to FIG. 9 is executed for each of the plurality of slot game areas. When the enhanced display processing is called, the CPU 106 executes the enhanced display processing shown in FIG. 22 for each of the slot game areas in step S26, step S29 in FIG. 5 and in step S44 in FIG. 7.

In the enhanced display processing shown in FIG. 22, the processing in step S121 and step S122 is executed for two or more areas in which symbols forming a winning combination are rearranged on the payline and a payout is awarded among the slot game areas. Here, a case is described, in which a payout is awarded in the slot game area A4 and the slot game area A7.

First, the processing in step S121 and step S122 is executed for the slot game area A4. When symbols forming a winning combination are rearranged on the payline and a payout is awarded, the CPU 106 produces an enhanced display of the area (the area A4) in which a payout is awarded on the upper display 33 as shown in FIG. 21 (step S121). In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, on the upper display 33, an image of the enhanced display of the area in which a payout is awarded is displayed. In the example shown in FIG. 21, the area A4b, which is an enlarged view of the area A4 in which a winning combination is formed, is displayed on the upper display 33.

Further, the CPU 106 releases the enhanced display produced in step S101 (step S122). Specifically, the CPU 106 generates an image display command signal to release the enhanced display of the area in which the payout is awarded and inputs it to the upper display controller 150. Due to this, on the upper display 33, the enhanced display is released and a screen on which the normal slot game is executed is displayed.

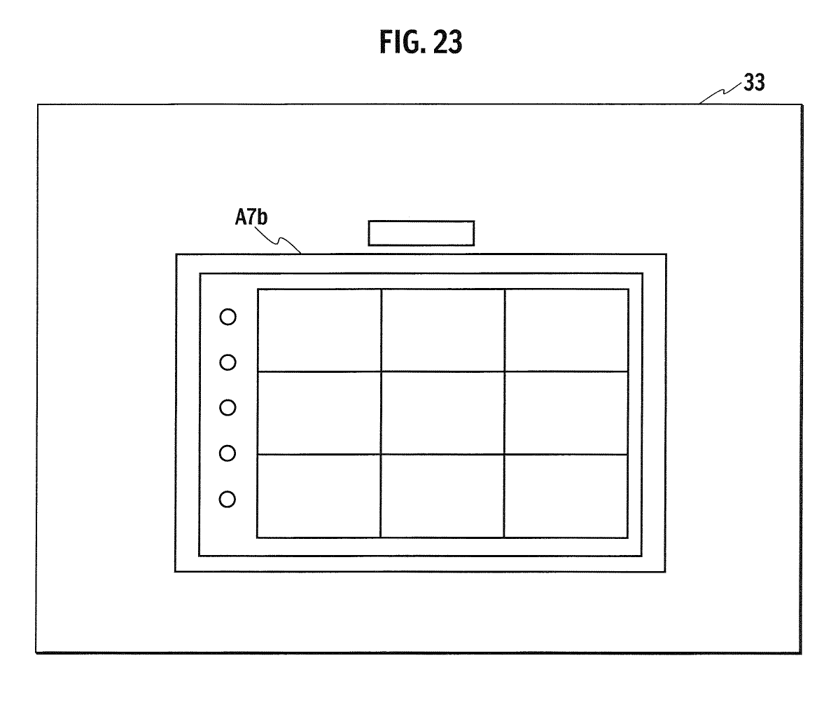

Next, the CPU 106 executes the processing in step S121 and step S122 for the slot game area A7, which is another area in which a payout is awarded. When symbols forming a winning combination are rearranged on the payline and a payout is awarded, the CPU 106 produces an enhanced display of the area (area A7) in which a payout is awarded on the upper display 33 as shown in FIG. 23 (step S121). In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, on the upper display 33, an image of the enhanced display of the area in which a payout is awarded is displayed. In the example shown in FIG. 23, an area A7b, which is an enlarged view of the area A7 in which a winning combination is formed, is displayed on the upper display 33.

Further, the CPU 106 releases the enhanced display produced in step S121 (step S122). Specifically, the CPU 106 generates an image display command signal to release the enhanced display of the area A4 in which the payout is awarded and inputs it to the display controller 140. Due to this, on the upper display 33, the enhanced display is released and a screen on which the normal slot game is executed is displayed.

When the processing in step S121 and step S122 ends for all the areas in which a payout is awarded, the CPU 106 determines whether or not a predetermined condition has been established (step S123). When it is determined that the predetermined condition has not been established, the CPU 106 further executes the processing in step S121 and step S122 for all the areas in which a payout is awarded. Here, the predetermined condition may be a time of enhanced display or the start of the next slot game.

On the other hand, when it is determined that the predetermined condition has been established, the CPU 106 ends the enhanced display processing.

In this manner, in the slot machine according to the third variation, it is possible to produce the enhanced displays of the two or more slot game areas in which a payout is awarded sequentially on the upper display 33 even when a payout is awarded in the two or more slot game areas. Specifically, when a payout is awarded in the area A4 and the area A7, the screen shown in FIG. 21, which is an enlarged view of the area A4, and the screen shown in FIG. 23, which is an enlarged view of the area A7 are displayed sequentially on the upper display 33. Due to this, it is possible to instantaneously recognize in which slot game area a payout is awarded even if a payout is awarded in two or more slot game areas.

Further, when a payout is awarded in two or more slot game areas, the enhanced displays of the areas in which the payout is awarded are produced sequentially. As a result, the screens to be displayed on the upper display 33 are deployed one after another, and therefore, it is possible to heighten the joy of a player for a payout and increase the player's desire to play a game.

In the above third variation, as an enhanced display, a display, which is an enlarged view of the area in which a winning combination is formed, is displayed, however, the present invention is not limited to this. The enhanced displays may include a flashing display of the entire area, a flashing display of the frame of the area, a display of animation, etc.

(Fourth Variation)

In the above embodiment, the case is described, in which the enhanced display is produced on the liquid crystal display 16 on which the slot game is being executed when a payout is awarded only in the slot game area, however, in a fourth variation, a case is described, in which an enhanced display is produced on a display different from the liquid crystal display 16 on which the slot game is being executed and at the same time, the slot game area in which the payout is awarded is deleted from the liquid crystal display 16.

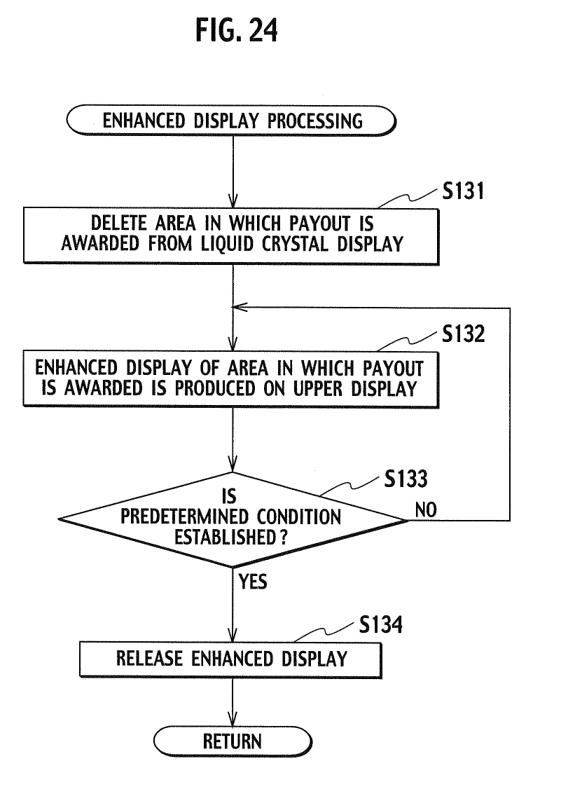

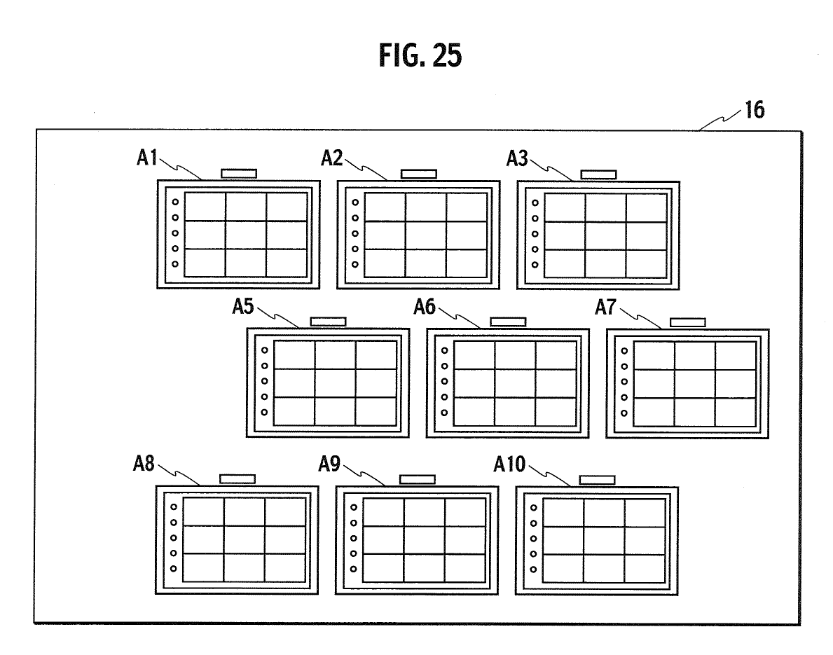

The enhanced display processing of the area in which a payout is awarded is described in the fourth variation of the present invention with reference to FIG. 21, FIG. 24, and FIG. 25. FIG. 24 is a flowchart for describing the enhanced display processing according to the fourth variation of the present invention.

The CPU 106 causes the area (in the example shown in FIG. 25, the area A4) in which symbols forming a winning combination are rearranged and a payout is awarded among the slot game areas to be deleted from the liquid crystal display 16 (step S131). Specifically, the CPU 106 generates an image display command signal to delete the area in which a payout is awarded and inputs it to the display controller 140.

Next, as shown in FIG. 21, an enhanced display of the area in which the payout is awarded (in the example shown in FIG. 21, the area A4) is produced on the upper display 33 (step S132). In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, on the upper display 33, an image of the enhanced display of the area in which a payout is awarded is displayed. In the example shown in FIG. 21, the area A4b, which is an enlarged view of the area A4 in which a winning combination is formed, is displayed on the upper display 33.

Next, the CPU 106 determines whether or not a predetermined condition has been established (step S133) and when it is determined that the predetermined condition has not been established, the CPU 106 waits for the predetermined condition to be established. Here, the predetermined condition may be a time of enhanced display or the start of the next slot game.

On the other hand, when it is determined that a predetermined condition has been established, the CPU 106 releases the enhanced display produced in step S132 and ends the enhanced display processing (step S134). Specifically, the CPU 106 generates an image display command signal to release the enhanced display of the area in which the payout is awarded and inputs it to the upper display controller 150. Due to this, on the upper display 33, the enhanced display is released and a screen on which the normal slot game is executed is displayed.

In this manner, in the slot machine according to the fourth variation, it is possible to produce an enhanced display of the slot game area in which a payout is awarded on the upper display 33 as well as deleting the area in which the payout is awarded from the liquid crystal display 16 on which the slot game is being executed even when two or more slot game areas are displayed on the liquid crystal display 16 and the slot game in each area is executed simultaneously. Due to this, it is possible for a player to instantaneously recognize in which slot game area a payout is awarded.

Further, the enhanced display of the slot game area in which a payout is awarded is produced on the upper display 33, and therefore, it is possible to enhance the ambience of the game and make a player have a greater desire to play a game.

Furthermore, the area in which a payout is awarded is displayed on the upper display 33 different from the liquid crystal display 16 as well as the area in which a payout is awarded is deleted from the liquid crystal display 16 on which the slot game is being executed, and therefore, it is possible to change the player's line of sight. As a result, it is possible to heighten the joy of the player for a payout and make the player have a greater desire to play a game.

In the above embodiment, as an enhanced display, a display, which is an enlarged view of the area in which a winning combination is formed, is displayed on the upper display 33, however, the present invention is not limited to this. The enhanced displays may include a flashing display of the entire area, a flashing display of the frame of the area, a display of animation, etc.

(Fifth Variation)

In the above embodiment, the case is described, where a payout is awarded only in one slot game area among the plurality of slot game areas, however, in a fifth variation, a case is described, where a payout is awarded in two or more slot game areas among the slot game areas. In the fifth variation, a case is described, in which an enhanced display is produced on a display different from the liquid crystal display 16 on which the slot game is being executed and at the same time, the slot game area in which the payout is awarded is deleted from the liquid crystal display 16.

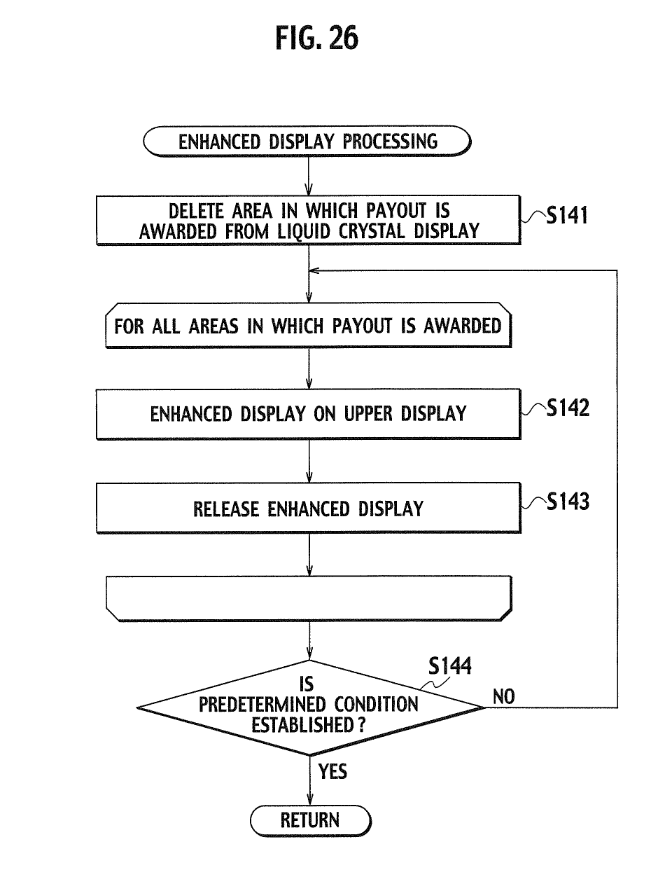

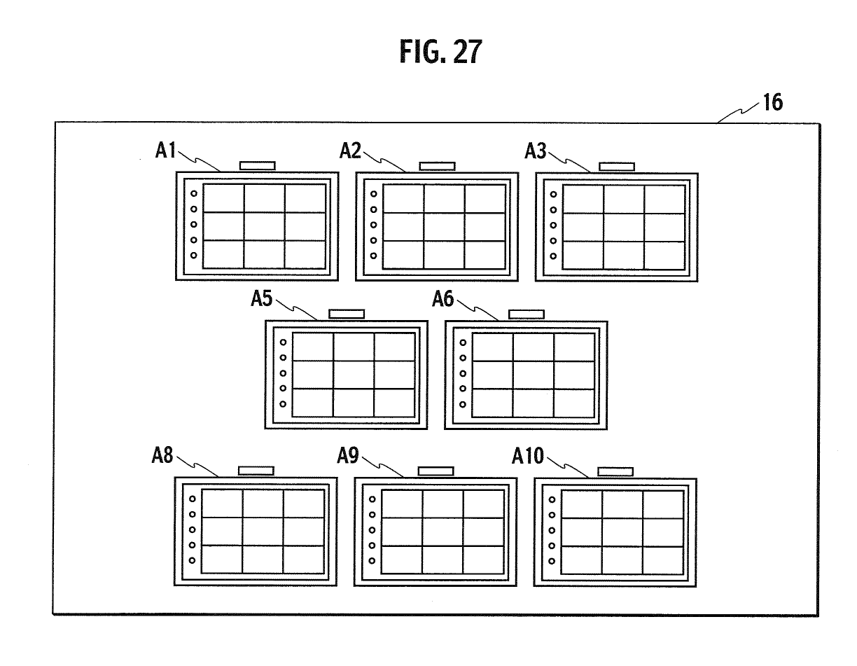

The enhanced display processing of the area in which a payout is awarded is described in the fifth variation of the present invention with reference to FIG. 21, FIG. 23, FIG. 26, and FIG. 27.

As shown in step S16 in FIG. 4, the processing shown in FIG. 5 to FIG. 9 is executed for each of the plurality of slot game areas. When the enhanced display processing is called, the CPU 106 executes the enhanced display processing shown in FIG. 22 for each of the slot game areas in step S26, step S29 in FIG. 5 and in step S44 in FIG. 7.

In the enhanced display processing shown in FIG. 26, the two or more areas (in the example shown in FIG. 27, the area A4 and the area A7) in which symbols forming a winning combination are rearranged on the payline and a payout is awarded among the slot game areas are deleted from the liquid crystal display 16 (step S141). Specifically, the CPU 106 generates an image display command signal to delete the areas in which the payout is awarded and inputs it to the display controller 140.

Next, the processing in step S142 and step S143 is executed for the two or more areas in which symbols forming a winning combination are rearranged on the payline and a payout is awarded among the slot game areas. Here, a case is described, in which a payout is awarded in the slot game area A4 and the slot game area A7.

First, the processing in step S142 and step S143 for the slot game area A4 is executed. When symbols forming a winning combination are rearranged on the payline and a payout is awarded, the CPU 106 produces an enhanced display of the area (area A4) in which a payout is awarded on the upper display 33 as shown in FIG. 21 (step S142). In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, on the upper display 33, an image of the enhanced display of the area in which a payout is awarded is displayed. In the example shown in FIG. 21, the area A4b, which is an enlarged view of the area A4 in which a winning combination is formed, is displayed on the upper display 33.

Further, the CPU 106 releases the enhanced display produced in step S142 (step S143). Specifically, the CPU 106 generates an image display command signal to release the enhanced display of the area A4 in which the payout is awarded and inputs it to the upper display controller 150. Due to this, on the upper display 33, the enhanced display is released and a screen on which the normal slot game is executed is displayed.

Next, the CPU 106 executes the processing in step S142 and step S143 for the slot game area A7, which is another area in which a payout is awarded. When symbols forming a winning combination are rearranged on the payline and a payout is awarded, the CPU 106 produces an enhanced display of the area (area A7) in which the payout is awarded on the upper display 33 as shown in FIG. 23 (step S142). In other words, the CPU 106 generates an image display command signal to produce an enhanced display of the area in which the payout is awarded and inputs it to the upper display controller 150. When the image display command is input from the CPU 106, the upper display controller 150 generates a drive signal to drive the upper display 33 based on the image display command and outputs the generated drive signal to the upper display 33. Due to this, on the upper display 33, an image of the enhanced display of the area in which a payout is awarded is displayed. In the example shown in FIG. 23, the area A7b, which is an enlarged view of the area A7 in which a winning combination is formed, is displayed on the upper display 33.

Further, the CPU 106 releases the enhanced display produced in step S142 (step S143). Specifically, the CPU 106 generates an image display command signal to release the enhanced display of the area A7 in which the payout is awarded and inputs it to the display controller 140. Due to this, on the upper display 33, the enhanced display is released and a screen on which the normal slot game is executed is displayed.

When the processing in step S142 and step S143 ends for all the areas in which a payout is awarded, the CPU 106 determines whether or not a predetermined condition has been established (step S144). When it is determined that the predetermined condition has not been established, the CPU 106 further executes the processing in step S142 and step S143 for all the areas in which a payout is awarded. Here, the predetermined condition may be a time of enhanced display or the start of the next slot game.

On the other hand, when it is determined that the predetermined condition has been established, the CPU 106 ends the enhanced display processing.

In this manner, in the slot machine according to the fifth variation, it is possible to produce the enhanced displays of the two or more slot game areas in which the payout is awarded sequentially on the upper display 33 even when a payout is awarded in the two or more slot game areas. Specifically, when a payout is awarded in the area A4 and the area A7, the screen shown in FIG. 21, which is an enlarged view of the area A4, and the screen shown in FIG. 23, which is an enlarged view of the area A7 are displayed sequentially on the upper display 33. Due to this, it is possible to instantaneously recognize in which slot game area a payout is awarded even if a payout is awarded in two or more slot game areas.

Further, when a payout is awarded in two or more slot game areas, the enhanced displays of the areas in which the payout is awarded are produced sequentially. As a result, the screens to be displayed on the upper liquid crystal display 33 are deployed one after another, and therefore, it is possible to heighten the joy of a player for a payout and increase the player's desire to play a game.

In the slot machines and the playing methods thereof according to the present invention, the slot game is executed in the activated slot game area(s) among the plurality of slot game areas. An enhanced display of the slot game area(s) in which a winning combination is formed is produced on the display. As a result, even if a player is caused to play a plurality of slot games in one play, it is possible for the player to easily recognize that in which slot game a winning combination is formed, and thus, the entertaining nature can be improved.

In the above third variation, as an enhanced display, the area in which a winning combination is formed is enlarged and displayed, however, the present invention is not limited to this. The enhanced displays may include a flashing display of the entire area, a flashing display of the frame of the area, a display of animation, etc.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A slot machine comprising:
a display displaying a plurality of slot game areas for executing a slot game of rearranging a plurality of arranged symbols;
an input device for reading a bet of credits by a player; and
a controller operable to:
(a) activate a slot game area according to the bet of credits read by the input device among the plurality of slot game areas;
(b) execute the slot game in the activated slot game area; and
(c) produce, when a winning combination awarding a payout is formed in any of the plurality of slot game areas, an enhanced display of the slot game area in which the winning combination is formed on the display.

2. The slot machine as claimed in claim 1, wherein the controller further produces, when a winning combination awarding a payout is formed in a plurality of slot game areas among the slot game areas, an enhanced display of the plurality of slot game areas in which the winning combination is formed sequentially on the display.

3. A slot machine comprising:
a display displaying a plurality of slot game areas for executing a slot game of rearranging a plurality of arranged symbols;
an input device for reading a bet of credits by a player; and
a controller operable to:
(a) activate a slot game area according to the bet of credits read by the input device among the plurality of slot game areas;
(b) execute the slot game in the activated slot game area; and
(c) produce, when a winning combination awarding a payout is formed in any of the plurality of slot game areas, an enhanced display of the slot game area in which the winning combination is formed on the display and a sub display different from the display.

4. The slot machine as claimed in claim 3, wherein the controller further produces, when a winning combination awarding a payout is formed on a payline in a plurality of slot game areas among the slot game areas, an enhanced display of the plurality of slot game areas in which the winning combination is formed sequentially on the display and the sub display.

5. A slot machine comprising:
a display displaying a plurality of slot game areas for executing a slot game of rearranging a plurality of arranged symbols;
an input device for reading a bet of credits by a player; and
a controller operable to:
(a) activate a slot game area according to the bet of credits read by the input device among the plurality of slot game areas;
(b) execute the slot game in the activated slot game area;
(c) delete, when a winning combination awarding a payout is formed in any of the plurality of slot game areas, the slot game area displayed on the display and in which the winning combination is formed from the display; and
(d) produce an enhanced display of the slot game area in which the winning combination is formed on a sub display different from the display.

6. The slot machine as claimed in claim 5, wherein the controller further produces, when a winning combination awarding a payout is formed in a plurality of slot game areas among the slot game areas, an enhanced display of the plurality of slot game areas in which the winning combination is formed sequentially on the sub display.

7. A playing method of a slot machine comprising the steps of:
betting a credit;
determining a slot game area to be activated according to the bet among a plurality of slot game areas in order to execute a slot game of rearranging arranged symbols;
executing the slot game in the activated slot game area; and
producing, when a winning combination awarding a payout is formed in any of the plurality of slot game areas, an enhanced display of the slot game area in which the winning combination is formed on the display.

8. The playing method of a slot machine as claimed in claim 7, wherein the playing method of a slot machine further comprises the step of producing, when a winning combination awarding a payout is formed in a plurality of slot game areas among the slot game areas, an enhanced display of each of the plurality of slot game areas in which the winning combination is formed sequentially on the display.

9. A playing method of a slot machine comprising the steps of:
betting a credit;
determining a slot game area to be activated according to the bet among a plurality of slot game areas in order to execute a slot game of rearranging arranged symbols;
executing the slot game in the activated slot game area; and
producing, when a winning combination awarding a payout is formed in any of the plurality of slot game areas, an enhanced display of the slot game area in which the winning combination is formed on the display and a sub display different from the display.

10. The playing method of a slot machine as claimed in claim 7, wherein the playing method of a slot machine further comprises the step of producing, when a winning combination awarding a payout is formed in a plurality of slot game areas among the slot game areas, an enhanced display of each of the plurality of slot game areas in which the winning combination is formed sequentially on the display and the sub display.

11. A playing method of a slot machine comprising the steps of:
betting a credit;
determining a slot game area to be activated according to the bet among a plurality of slot game areas in order to execute a slot game of rearranging arranged symbols;
executing the slot game in the activated slot game area;
deleting, when a winning combination awarding a payout is formed in any of the plurality of slot game areas, the slot game area displayed on the display and in which the winning combination is formed from the display; and
producing an enhanced display of the slot game area in which the winning combination is formed on a sub display different from the display.

12. The playing method of a slot machine as claimed in claim 11, wherein the playing method of a slot machine further comprises the step of producing, when a winning combination awarding a payout is formed in a plurality of slot game areas among the slot game areas, an enhanced display of each of the plurality of slot game areas in which the winning combination is formed sequentially on the sub display.
